(19) United States
(12) Patent Application Publication
(10) Pub. No.: US 2003/0169148 A1
(43) Pub. Date: Sep. 11, 2003

(54) Electronic key system

(75) Inventors: Kimitake Takamura, Aichi (JP); Hisashi Kato, Aichi (JP)

Correspondence Address: SYNNESTVEDT & LECHNER, LLP, 2600 ARAMARK TOWER, 1101 MARKET STREET, PHILADELPHIA, PA, 191072950

(73) Assignee: Kabushiki Kaisha Tokai Rika Denki Seisakusho

(21) Appl. No.: 10/378,751

(22) Filed: Mar. 4, 2003

(30) Foreign Application Priority Data
Mar. 6, 2002 (JP) 2002-060499

(51) Int. Cl. H04Q 1/00

(52) U.S. Cl. 340/5.7

(57) ABSTRACT

An electronic key system includes an electronic key, a key cylinder, a transponder and an antenna. The key cylinder has a key insertion port to which an insertion portion of the electronic key is inserted. The key cylinder has an exposed end at which the key insertion port is formed, and a bottom spaced from the exposed end. The transponder is activated by electromotive force included by an externally applied electromagnetic field. The antenna receives a transponder signal transmitted by the transponder. The antenna is located in the vicinity of the bottom of the key cylinder.

### BACKGROUND OF THE INVENTION

The present invention relates to an electronic key system used for a door of, for example, a vehicle, such as an automobile, and a house.

For example, smart ignition devices are known as devices utilizing electronic key system. Such an electronic key system includes a first transmit-receive device provided in an electronic key and a second transmit-receive device provided in a vehicle. An ID request signal is transmitted by the second transmit-receive device. In response to the ID request signal, the first transmit-receive device sends an ID signal to the second transmit-receive device. When receiving the ID signal, the second transmit-receive device verifies the ID and then outputs an engine start permission signal to a start permission device.

As shown in FIG. 10, an electronic key 102, which is manipulated by a user, has a battery (not shown) as a power source. In consideration of a case where the battery exhausts, the electronic key 102 has a transponder 103 as a first transmit-receive device for emergency. The electronic key 102 has an insert portion 105 and a key grip 104. The transponder 103 is accommodated in the key grip 104. A second transmit-receive device (not shown) intermittently generates an electromagnetic field in the vicinity of a key cylinder 115 for activating the transponder 103. When activated by electromotive force included by an externally applied electromagnetic field, the transponder 103 transmits a transponder signal to the vehicle. The transponder signal is received by a coil antenna 112 mounted on the vehicle. The coil antenna 112 is located in the vicinity of a keyhole 111 of the key cylinder 115, where transmission with the transponder 103 can be established. The coil antenna 112 surrounds the entire keyhole 111. This is because the orientation of the insert portion 105 of the electronic key 102 can vary when the user inserts the electronic key 102 into the keyhole 111. The coil antenna 112 has a predetermined diameter.

When the user inserts the electronic key 102 into the keyhole 111, the transponder 103 in the key grip 104 enters the range of the electromagnetic field (communication area) generated by the on-vehicle transmit-receive device. At this time, electromotive force is generated in the coil of the transponder 103. Accordingly, the transponder 103 transmits a transponder signal including an ID code to the vehicle. The transponder signal from the electronic key 102 is received by the coil antenna 112 of the vehicle. The transponder signal is then sent to an immobilizer ECU 114 through an amplifier 113.

The coil antenna 112 is located in the vicinity and about the entire keyhole 111 of the key cylinder 115. When there is an attempt of car theft or some sort of illegal act using a wire or a pick, the distal end of the wire or the pick easily reaches the keyhole 111 of the key cylinder 115. The coil antenna 112 is therefore likely to be damaged by external impacts.

### SUMMARY OF THE INVENTION

Accordingly, it is an objective of the present invention to provide an electronic key system having a high level of security.

To achieve the object, the present invention provides an electronic key system. The electronic key system includes an electronic key, a key cylinder, a transponder and an antenna. The electronic key has an insertion portion. The key cylinder has a key insertion port to which the insertion portion is inserted. The key cylinder has an exposed end at which the key insertion port is formed, and a bottom spaced from the exposed end. The transponder is activated by electromotive force included by an externally applied electromagnetic field. The antenna receives a transponder signal transmitted by the transponder. The antenna is located in the vicinity of the bottom of the key cylinder.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram showing the electrical configuration of an electronic key system according to a first embodiment of the present invention;

FIG. 2 is a diagrammatic view showing the electronic key system of the first embodiment;

FIG. 3(a) is a front view illustrating the distal end of the insert portion shown in FIG. 2;

FIG. 3(b) is an enlarged side view illustrating the distal end of the insert portion shown in FIG. 2;

FIG. 4(a) is a front view illustrating the distal end of an insert portion according to another modification of the first embodiment;

FIG. 4(b) is an enlarged side view illustrating the distal end of the insert portion shown in FIG. 4(a);

FIG. 5(a) is a front view illustrating the distal end of a key plate according to another modification of the first embodiment;

FIG. 5(b) is an enlarged side view of FIG. 5(a); and

FIG. 6(a) is a front view illustrating the distal end of an insertion portion according to a second embodiment;

FIG. 6(b) is an enlarged side view of FIG. 6(a); and

FIG. 7(a) is a front view illustrating the distal end of an insertion portion according to a third embodiment;

FIG. 7(b) is an enlarged side view of FIG. 7(a); and

FIG. 8(a) is a front view illustrating the distal end of an insertion portion according to a fourth embodiment;

FIG. 8(b) is an enlarged side view of FIG. 8(a); and

FIG. 9(a) is a front view illustrating the distal end of an insertion portion according to a seventh embodiment;

FIG. 9(b) is an enlarged side view of FIG. 9(a); and

FIG. 10 is a diagrammatic view showing a prior art electronic key system.

### DETAILED DESCRIPTION OF THE PREFERRED EMBODIMENTS

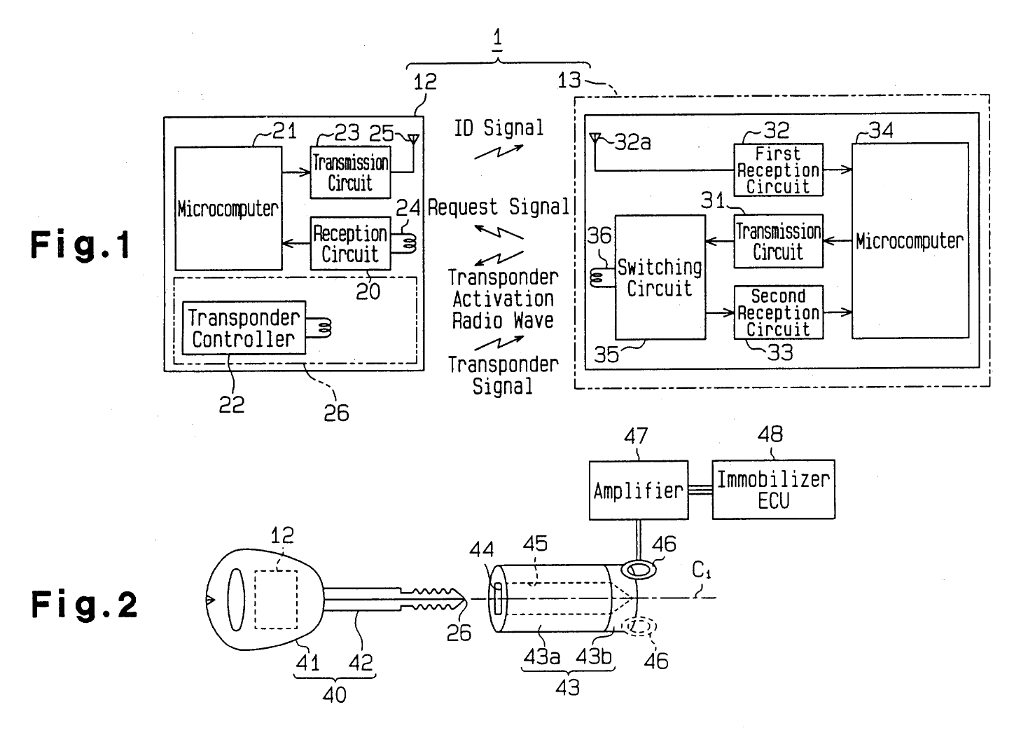

A first embodiment of the present invention will now be described with reference to FIGS. 1 to 3.

As shown in FIGS. 1 and 2, an electronic key system 1 includes a first transmit-receive device 12 provided in an electronic key 40 and a second transmit-receive device 13 provided in a vehicle (not shown).

The second transmit-receive device 13 includes a transmission circuit 31, first and second reception circuits 32, 33, a microcomputer 34, and a switching circuit 35. The transmission circuit 31 and the reception circuits 32, 33 are connected to the microcomputer 34. The transmission circuit 31 and the second reception circuit 33 are connected to a transmit-receive antenna 36 through the switching circuit 35. The transmit-receive antenna 36 generates electromagnetic field, which is transponder activating radio waves. The transmit-receive antenna 36 also transmits and receives transponder signals. The switching circuit 35 selectively connects the transmit-receive antenna 36 to the transmission circuit 31 and the second reception circuit 33. The first reception circuit 32 is connected to a reception antenna 32a, which receives an ID signal from the first transmit-receive device 12. The transmission circuit 31 converts the transponder activating signal from the microcomputer 34 into a radio wave having a predetermined frequency, thereby generating the transponder activating radio wave. The transmission circuit 31 then outputs the transponder activating radio wave through the transmit-receive antenna 36. That is, a request signal and the transponder activating radio wave are both output from the transmit-receive antenna 36.

The first reception circuit 32 receives ID signals from the first transmit-receive device 12 through the reception antenna 32a. The first reception circuit 32 demodulates an ID signal into a pulse signal, thereby generating a reception signal. The first reception circuit 32 then sends the reception signal to the on-vehicle microcomputer 34. At this time, the transmit-receive antenna 36 is connected to the second reception circuit 33 by way of the switching circuit 35. The second reception circuit 33 receives transponder signals from the first transmit-receive device 12 through the transmit-receive antenna 36. The second reception circuit 33 demodulates a transponder signal into a pulse signal, thereby generating a reception signal. The second reception circuit 33 then sends the reception signal to the microcomputer 34.

An engine starting device (not shown) is electrically connected to the microcomputer 34. The microcomputer 34 includes a CPU, a RAM, and a ROM (neither is shown) and selectively outputs request signals and transponder signals. When receiving a reception signal including an ID code, the microcomputer 34 compares the ID code in the reception signal with a preset ID code (ID code verification). If the ID codes match, the microcomputer 34 sends a start permission signal to the engine starting device.

When receiving a reception signal including a transponder code, the microcomputer 34 compares the transponder code in the reception signal with a preset transponder code (transponder code verification). If the transponder codes match, the microcomputer 34 sends a start permission signal to the engine starting device.

The first transmit-receive device 12 includes a reception circuit 20, a microcomputer 21, a transmission circuit 23, and a transponder 26. The reception circuit 20 receives request signals from the second transmit-receive device 13 through an LF reception antenna 24. When receiving a request signal from the reception circuit 20, the microcomputer 21 outputs an ID signal including a preset ID code. The transmission circuit 23 demodulates the ID signal into a radio wave of a predetermined frequency and sends the radio wave to the second transmit-receive device 13 through the antenna 25.

The transponder 26 is activated by electromotive force included by an externally applied electromagnetic field. The transponder 26 includes a transponder controller 22. When receiving a sufficient amount of energy from electromagnetic wave, the transponder controller 22 outputs a transponder signal including a predetermined transponder ID code (transponder code). Specifically, when receiving a transponder activation radio wave from the second transmit-receive device 13, the transponder controller 22 outputs a transponder signal.

Referring to FIG. 2, the transponder verification is executed when the user inserts the electronic key 40 into a key cylinder 43 located in a passenger compartment. The key cylinder 43 includes a key insertion port 44 and an exposed end that is exposed to the exterior of the vehicle. The part of the key cylinder 43 other than the exposed end is isolated from the exterior by a panel (not shown) of the vehicle. The transponder 26 is attached to the distal end of the electronic key 40. The transponder signal is received by a coil antenna 46 located in the vicinity of the bottom of the key cylinder 43. At least one coil antenna 46 is provided at a position where communication with the transponder 26 can be established when the electronic key 40 is inserted. In consideration of the communication range of the transponder 26, the coil antenna 46 is arranged to be close to the distal end of the electronic key 40 when the key is inserted into the key cylinder 43. Communication between the electronic key 40 and the transponder 26 takes place at the bottom of the key cylinder 43. The coil antenna 46 is preferably displaced from the center axis C₁ of the electronic key 40 when inserted into the key cylinder 43. This arrangement is advantageous to prevent wires and picks inserted into the key insertion port 44 from reaching the coil antenna 46. The coil antenna 46 is connected to an immobilizer ECU 48 through an amplifier 47.

The key cylinder 43 includes a metal portion 43a and a resin portion 43b. The resin portion 43b is located at the bottom of the key cylinder 43. When the electronic key 40 is inserted into the key cylinder 43, the arrangement of the resin portion 43b prevents the transponder 26 of the electronic key 40 from being influenced by metal, which is a magnetic substance. A keyhole 45 extends from the key insertion port 44 toward the bottom of the key cylinder 43. When the electronic key 40 is inserted into the key cylinder 43, the distal end of the electronic key 40 is moved along the keyhole 45 toward the bottom of the key cylinder 43. When the distal end of the electronic key 40 reaches the electromagnetic field generated at the vehicle, electromotive force is generated in the coil of the transponder 26. Accordingly, a transponder signal is sent to the vehicle. Since the coil antenna 46 is located in the vicinity of the distal end of the electronic key 40, the coil antenna 46 receives the transponder signal from the transponder 26. The transponder signal received by the coil antenna 46 is compared with a preset transponder code in the second transmit-receive device 13. That is, the ID verification is executed.

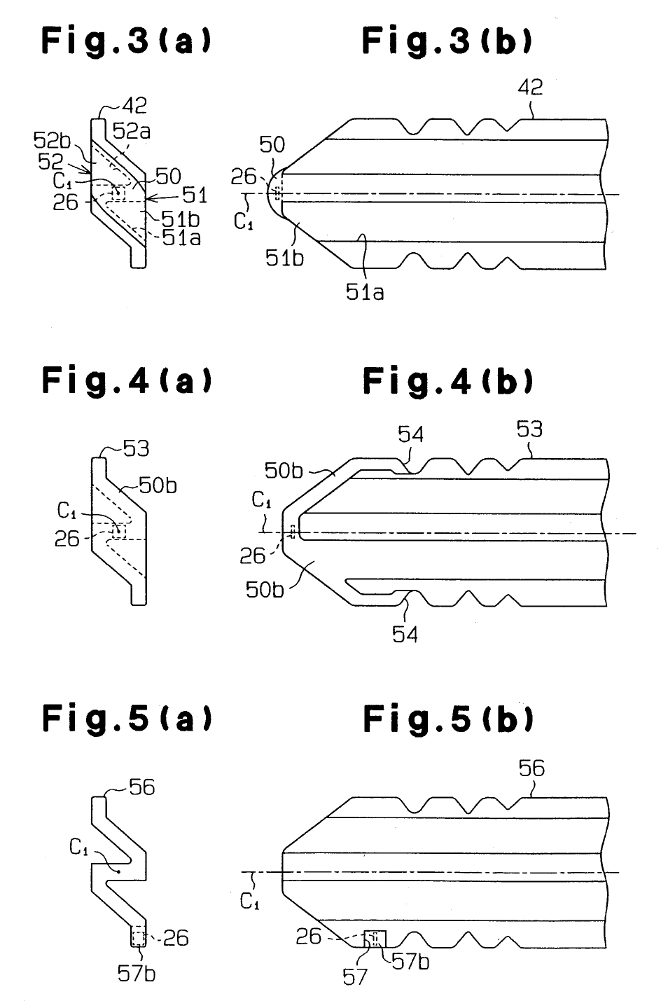

The electronic key 40 includes a resin key grip 41 held by the user and a metal insertion portion 42. FIGS. 3(a) and 3(b) show an embodiment in which the insertion portion 42 has an N-shaped cross-section.

As shown in FIGS. 3(a) and 3(b), a V-shaped first groove 51a is formed in a first surface 51 of the insertion portion 42. The first groove 51a extends parallel to the center axis C₁. A V-shaped second groove 52a is formed on a second surface 52, which is opposite from the first surface 51. The second groove 52a also extends parallel to the center axis C₁. Elongated resin portions 51b, 52b are formed in the grooves 51a, 52a, respectively. The transponder 26 is attached to the distal end of the insertion portion 42 and is located on the center axis C₁ of the electronic key 40. To minimize influence by metal, or magnetic substance, the entire transponder 26 is embedded in a resin portion 50 and is spaced from the metal surface of the insertion portion 42 by a predetermined distance. The resin portions 51b, 52b are coupled to the distal resin portion 50, which seals the transponder 26.

This embodiment provides the following advantages.

The transponder 26 is attached to the distal end of the insertion portion 42. The coil antenna 46 for receiving transponder signals is located at the bottom of the key cylinder 43. For example, if somebody tries to illegally access the key system by inserting a wire or a pick in the key cylinder 43, the wire or the pick does not easily reach the coil antenna 46. Therefore, the coil antenna 46 is prevented from being broken. This improves the level of security of the electronic key system 1.

The transponder 26 is located on the center axis C₁ of the electronic key 40. Therefore, even if the user inserts the electronic key 40 into the key cylinder 43 without paying attention to the orientation of the insertion portion 42, the transponder 26 is located at a predetermined position in the key cylinder 43. Therefore, when the electronic key 40 is inserted in the key cylinder 43, the position of the transponder 26 is easily determined. Thus, the position and the orientation of the coil antenna 46, which receives the transponder signal, are easily set.

The coil antenna 46 is located in the vicinity of the distal end of the insertion portion 42 when the electronic key 40 is inserted in the key cylinder 43. Therefore, the distance of communication between the transponder 26 of the electronic key 40 and the vehicle is relatively short. Thus, the size of the coil antenna 46 for receiving transponder signals can be minimized.

The transponder 26 is embedded in the resin portion 50 and is separated from the metal surface of the insertion portion 42. The configuration minimizes the influence of metal, which is magnetic substance, upon the transponder 26. This improves the communication performance of the electronic key system 1.

The resin portions 51b, 52b are coupled to the distal resin portion 50 at the distal end of the insertion portion 42. The transponder 26 is fixed to the insertion portion 42 not only by the distal resin portion 50 but also by the resin portions 51b, 52b, which prevents the transponder 26 from falling off the distal end of the insertion portion 42. Therefore, the transponder 26 is reliably located at a predetermined position in the distal end of the insertion portion 42.

The embodiment shown in FIGS. 3(a) and 3(b) may be modified as shown in FIGS. 4(a) and 4(b) by forming resin portions other than the resin portions 51b, 52b in the grooves 51a, 52a. In the modification of FIGS. 4(a) and 4(b), a resin portion 50b having a V-shaped cross-section is formed from the distal end of the insertion portion 53 to key notches 54. In this modification, the transponder 26 is embedded in the resin portion 50b and is held at the distal end of the insertion portion 53.

The embodiment of FIGS. 3(a) and 3(b) may be modified by displacing the transponder 26 from the center axis C₁. In a modification of FIGS. 5(a) and 5(b), an accommodating recess 57 is formed in a side of the insertion portion 56 where no key notches are formed. The transponder 26 is located in the accommodating recess 57 and is embedded in a resin portion 57b.

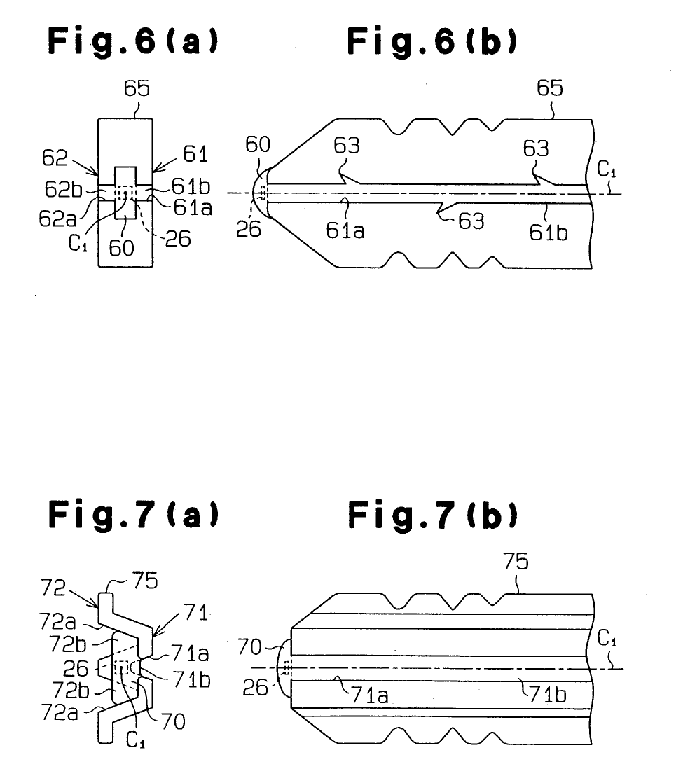

A second embodiment will now be described with reference to FIGS. 6(a) and 6(b). An electronic key system 1 of the second embodiment has a flat insertion portion 65. Like or the same reference numerals are given to those components that are like or the same as the corresponding components of the embodiment of FIGS. 1 to 3(b).

As shown in FIGS. 6(a) and 6(b), grooves 61a and 62a having U-shaped cross-section are formed on a first surface 61 and a second surface 62 of the insertion portion 65, respectively. The grooves 61a, 62a extend along the center axis C₁ of the electronic key 40. Notches 63 are alternately formed on the sides of each groove 61a, 62a. Each notch 63 narrows as the distance from the center axis C₁ increases. The distal end of each notch 63 is inclined toward the distal end of the insertion portion 65. Elongated resin portions 61b, 62b are formed in the grooves 61a, 62a, respectively. The resin of each resin portion 61b, 62b fills the notches 63 to the distal ends.

In addition to the advantages of the embodiment shown in FIGS. 1 to 3(b), this embodiment provides the following advantages.

The notches 63 are formed in part of each resin portion 61b, 62b. Therefore, the resin portions 61b, 62b are prevented from being displaced in the grooves 61a, 62a. Since the resin portions 61b, 62b are connected to a distal resin portion 60 in which the transponder 26 is embedded, the transponder 26 is reliably held at the distal end of the insertion portion 65.

A third embodiment will now be described with reference to FIGS. 7(a) and 7(b). An electronic key system 1 of the third embodiment has a insertion portion 75 having a W-shaped cross-section. Like or the same reference numerals are given to those components that are like or the same as the corresponding components of the embodiment shown in FIGS. 1 to 3(b).

As shown in FIGS. 7(a) and 7(b), a V-shaped first groove 71a is formed in a first surface 71 of the insertion portion 75. The groove 71a extends along the center axis C₁ of the electronic key 40. Two V-shaped second grooves 72a are formed on a second surface 72, which is opposite from the first surface 71. The second grooves 72a are located at the sides of the first groove 71a in the lateral direction. Elongated resin portions 71b, 72b are formed in the V-shaped grooves 71a, 72a, respectively. Since the resin portions 71b, 72b are connected to a resin portion 70, in which the transponder 26 is embedded, the transponder 26 is reliably held at the distal end of the insertion portion 75.

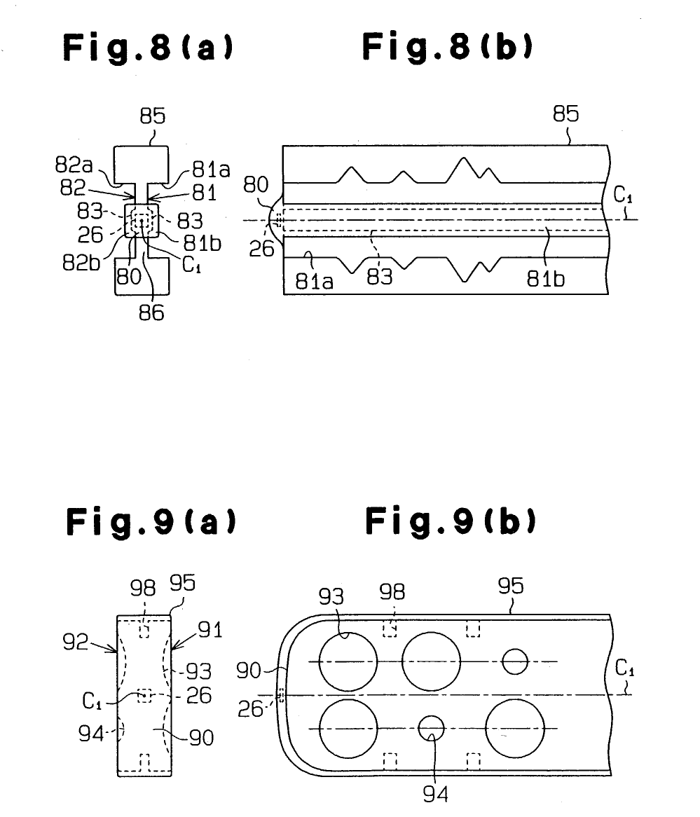

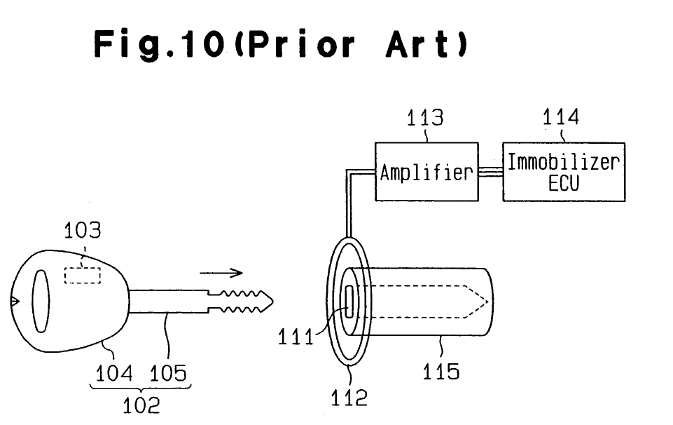

A fourth embodiment will now be described with reference to FIGS. 8(a) and 8(b). An electronic key system 1 of the fourth embodiment has a insertion portion 85 having a thin portion. Like or the same reference numerals are given to those components that are like or the same as the corresponding components of the embodiment shown in FIGS. 1 to 3(b).

As shown in FIGS. 8(a) and 8(b), grooves 81a and 82a having a U-shaped cross-section are formed on a first surface 81 and a second surface 82 of the insertion portion 85, respectively. A key pattern is formed in each groove 81a, 82a. An elongated reinforcing portion 83 is formed in each groove 81a, 82a. Each reinforcing portion 83 extends along the center axis C₁ of the electronic key 40. This reinforces a thin portion 86 of a thin plate type key, which has a relatively limited strength. Elongated resin portion 81b, 82b are formed in the grooves 81a, 82a, respectively. Each resin portion 81b, 82b covers the corresponding reinforcing portion 83 Since the resin portions 81b, 82b are connected to a distal resin portion 80, in which the transponder 26 is embedded, the transponder 26 is reliably held at the distal end of the insertion portion 85. The fourth embodiment thus has the same advantages as the first embodiment.

A fifth embodiment will now be described with reference to FIGS. 9(a) and 9(b). An electronic key system 1 of the fifth embodiment has a dimple-type insertion portion 95. Like or the same reference numerals are given to those components that are like or the same as the corresponding components of the embodiment shown in FIGS. 1 to 3(b).

As shown in FIGS. 9(a) and 9(b), unlocking recesses, which are large dimples 93 and a small dimples 94, are formed on first and second surfaces 91, 92 of the insertion portion 95. The distal end of the insertion portion 95 is substantially semicircular. Recesses 98 are formed on the sides of the insertion portion 95. A flattened resin portion 90 is integrally extends from the distal end to the sides of the insertion portion 95 The resin of the distal resin portion 90 fills the recesses 98. The transponder 26 is embedded in the distal resin portion 90 and is located in the center of the distal end of the insertion portion 95.

In addition to the advantages of the embodiment shown in FIGS. 1 to 3(b), this embodiment provides the following advantage.

Since part of the resin portion 90 is located in the recesses 98, the resin portion 90 is prevented from being displaced. Also, since the transponder 26 is embedded in the distal resin portion 90, the transponder 26 is reliably held at the distal end of the insertion portion 95.

The present invention may be embodied as follows.

In the embodiments shown in FIGS. 1 to 9(b), the electronic key system 1 is used against illegal acts such as car theft. The electronic key system 1 may be used against illegal acts for breaking in a house in general. For example, the system 1 may have an alarm that is selectively activated in response to an ID signal received by the microcomputer 34. That is, when the received ID signal matches with a registered signal, the alarm is not activated, and when the received ID signal does not match with the registered signal, the alarm is activated. In this case, one can unlock a door with a duplicate key. However, if there is no match of the ID signals, the alarm is activated to prevent the illegal act.

Therefore, the present examples and embodiments are to be considered as illustrative and not restrictive and the invention is not to be limited to the details given herein, but may be modified within the scope and equivalence of the appended claims.

1. An electronic key system, comprising:
an electronic key having an insertion portion;
a key cylinder having a key insertion port to which the insertion portion is inserted, wherein the key cylinder has an exposed end at which the key insertion port is formed, and a bottom spaced from the exposed end;
a transponder, which is activated by electromotive force included by an externally applied electromagnetic field; and
an antenna for receiving a transponder signal transmitted by the transponder, wherein the antenna is located in the vicinity of the bottom of the key cylinder.

2. The electronic key system according to claim 1, wherein the transponder is attached to a distal end of the insertion portion, and wherein, when the insertion portion is inserted into the key cylinder, the antenna is located in the vicinity of the distal end of the insertion portion.

3. The electronic key system according to claim 1, wherein the transponder is embedded in resin at the distal end of the insertion portion.

4. The electronic key system according to claim 1, wherein the transponder is located on a center axis of the insertion portion.

5. The electronic key system according to claim 1, wherein the key cylinder includes a metal portion and a resin portion, and wherein the antenna is located in the vicinity of the resin portion.

6. An electronic key system, comprising:
an electronic key having an insertion portion;
a key cylinder having a key insertion port to which the insertion portion is inserted, wherein the key cylinder has an exposed end at which the key insertion port is formed, and a bottom spaced from the exposed end;
a transponder, which is activated by electromotive force included by an externally applied electromagnetic field;
an antenna for receiving a transponder signal transmitted by the transponder, wherein the antenna is located in the vicinity of the bottom of the key cylinder, and is spaced from a center axis of the key cylinder by a predetermined distance.

7. The electronic key system according to claim 6, wherein the transponder is attached to a distal end of the insertion portion, and wherein, when the insertion portion is inserted into the key cylinder, the antenna is located in the vicinity of the distal end of the insertion portion.

8. The electronic key system according to claim 6, wherein the transponder is embedded in resin at the distal end of the insertion portion.

9. The electronic key system according to claim 6, wherein the transponder is located on a center axis of the insertion portion.

10. The electronic key system according to claim 6, wherein the key cylinder includes a metal portion and a resin portion, and wherein the antenna is located in the vicinity of the resin portion.
